(19) United States
(12) Patent Application Publication
(10) Pub. No.: US 2020/0145649 A1
(43) Pub. Date: May 7, 2020

(54) METHOD AND APPARATUS FOR REDUCING NOISE IN FREQUENCY-DOMAIN IN IMAGE CODING SYSTEM

(71) Applicant: LG Electronics Inc., Seoul (KR)

(72) Inventors: Seunghwan KIM, Seoul (KR); Seethal PALURI, Seoul (KR); Jungdong SEO, Seoul (KR); Sunmi YOO, Seoul (KR); Jaehyun LIM, Seoul (KR); Jin HEO, Seoul (KR)

(21) Appl. No.: 16/629,715

(22) PCT Filed: Jul. 10, 2017
(86) PCT No.: PCT/KR2017/007357

§ 371 Date: Jan. 9, 2020

(51) Int. Cl. H04N 19/105; H04N 19/132; H04N 19/61; H04N 19/159; H04N 19/46; H04N 19/176

(52) U.S. Cl. CPC H04N 19/105; H04N 19/132; H04N 19/176; H04N 19/159; H04N 19/46; H04N 19/61

(57) ABSTRACT

An image encoding method performed by an encoding apparatus of the present embodiment comprises the steps of: deriving a predicted block for a current block; deriving a frequency-domain predicted block by transforming the predicted block; deriving a frequency-domain modified predicted block based on the frequency-domain predicted block and frequency correlation coefficients; generating a modified predicted block by inversely transforming the frequency-domain modified predicted block; deriving a residual block based on an original block and the modified predicted block for the current block; and encoding and outputting information on a prediction mode and residual information on the residual block. According to the present embodiment, noise generated as a result of intra-prediction or inter-prediction can be reduced, and prediction performance can be enhanced.

### CROSS-REFERENCE TO RELATED APPLICATIONS

This application is the National Stage filing under 35 U.S.C. 371 of International Application No PCT/KR2017/007357, filed on Jul. 10, 2017, the contents of which a unit re hereby incorporated by reference herein in their entirety.

### TECHNICAL FIELD

The disclosure relates to an image coding technology, and more particularly, to a method and an apparatus for reducing noise in a frequency domain in an image coding system.

### BACKGROUND

Demand for high-resolution, high-quality images such as HD (High Definition) images and UHD (Ultra High Definition) images has been increasing in various fields. As the image data has high resolution and high quality, the amount of information or bits to be transmitted increases relative to the legacy image data. Therefore, when image data is transmitted using a medium such as a conventional wired/wireless broadband line or image data is stored using an existing storage medium, the transmission cost and the storage cost thereof are increased.

Accordingly, there is a need for a highly efficient image compression technique for effectively transmitting, storing, and reproducing information of high resolution and high quality images.

### SUMMARY

### Technical Problem

A technical problem of the disclosure lies in providing a method and an apparatus which increase image coding efficiency.

Another technical problem of the disclosure lies in providing a method and an apparatus which increase prediction performance.

Still another technical problem of the disclosure lies in providing a method and an apparatus for removing noise which is generated as a result of prediction.

Still another technical problem of the disclosure lies in providing a method which increases prediction performance while reducing amount of data of additional information.

### Solution to Problem

According to an embodiment of the disclosure, an image encoding method which is performed by an encoding apparatus is provided. The method includes determining a prediction mode for a current block, deriving a predicted block for the current block based on the prediction mode, deriving a frequency domain predicted block by transforming the predicted block, deriving a frequency domain modified predicted block based on the frequency domain predicted block and the frequency correlation coefficients, generating a modified predicted block by inverse-transforming the frequency domain modified predicted block, deriving a residual block based on an original block for the current block and the modified predicted block, and encoding and outputting information on the prediction mode and residual information for the residual block.

According to another embodiment of the disclosure, an encoding apparatus which performs image encoding is provided. The encoding apparatus includes a predictor which determines a prediction mode for a current block, and which derives a predicted block for the current block based on the prediction mode, a frequency domain noise remover which derives a frequency domain predicted block by transforming the predicted block, which derives a frequency domain modified predicted block based on the frequency domain predicted block and frequency correlation coefficients, and which generates a modified predicted block by inverse-transforming the frequency domain modified predicted block, a subtractor which derives a residual block based on an original block for the current block and the modified predicted block, and an entropy encoder which encodes and outputs information on the prediction mode and residual information for the residual block.

According to still another embodiment of the disclosure, an image decoding method which is performed by a decoding apparatus is provided. The method includes receiving image information including prediction information and residual information, deriving a prediction mode for a current block based on the prediction information; deriving a predicted block for the current block based on the prediction mode, deriving a frequency domain predicted block by transforming the predicted block, deriving a frequency domain modified predicted block based on the frequency domain predicted block and the frequency correlation coefficients, generating a modified predicted block by inverse-transforming the frequency domain modified predicted block, deriving a residual block based on the residual information, and generating a reconstructed block based on the modified predicted block and the residual block.

According to still another embodiment of the disclosure, a decoding apparatus which performs image decoding is provided. The decoding apparatus includes an entropy decoder which receives image information including residual information and prediction information, a predictor which derives a prediction mode for a current block based on the prediction information, and which derives a predicted block for the current block based on the prediction mode, a frequency domain noise remover which derives a frequency domain predicted block by transforming the predicted block, which derives a frequency domain modified predicted block based on the frequency domain predicted block and frequency correlation coefficients, and which generates a modified predicted block by inverse-transforming the frequency domain modified predicted block, a residual processor which derives a residual block based on the residual information, and a reconstruction unit which generates a reconstructed block based on the modified predicted block and the residual block.

### Advantageous Effects

According to the disclosure, it is possible to reduce noise generated as a result of intra prediction or inter prediction, and increase prediction performance.

According to the disclosure, it is possible to increase prediction performance while reducing amount of data of additional information.

According to the disclosure, it is possible to reduce amount of data necessary for residual information, and increase general coding efficiency.

### BRIEF DESCRIPTION OF THE DRAWINGS

FIG. 1 is a diagram schematically describing a configuration of a video encoding apparatus to which the disclosure may be applied.

FIG. 2 is a diagram schematically describing a configuration of a video decoding apparatus to which the disclosure may be applied.

FIG. 3 is a diagram schematically describing a configuration of a video encoding apparatus according to the disclosure.

FIG. 4 is a diagram schematically describing a configuration of a video decoding apparatus according to the disclosure.

FIG. 5 schematically represents a configuration of a frequency domain noise remover according to the disclosure.

FIG. 6 represents, by way of example, correlation coefficient blocks constituted by correlation coefficients.

FIG. 7 is a schematic representation of positions of integer and fractional samples for ¼ fractional unit sample interpolation in inter prediction.

FIG. 8 represents a frequency domain interference removal (interference reduction) method based on fractional samples according to an example of the disclosure.

FIG. 9 represents a frequency domain interference removal (interference reduction) method based on integer samples according to an example of the disclosure.

FIG. 10 represents motion vectors and reference pictures for inter prediction of the current block.

FIG. 11 represents an example of a frequency domain noise removal method in a case where bi-prediction is applied.

FIG. 12 represents another example of a frequency domain noise removal method in a case where bi-prediction is applied.

FIG. 13 represents a method for determining whether to perform frequency domain noise removal according to an example of the disclosure.

FIG. 14 represents a method for determining whether to perform frequency domain noise removal according to another example of the disclosure.

FIG. 15 represents a method for determining whether to perform frequency domain noise removal according to still another example of the disclosure.

FIG. 16 represents an example of frequency domain noise removal method according to the disclosure.

FIG. 17 schematically represents an image encoding method by an encoding apparatus according to the disclosure.

FIG. 18 schematically represents an image decoding method by a decoding apparatus according to the disclosure.

### DESCRIPTION OF EXEMPLARY EMBODIMENTS

The present disclosure may be modified in various forms, and specific embodiments thereof will be described and illustrated in the drawings. However, the embodiments are not intended for limiting the disclosure. The terms used in the following description are used to merely describe specific embodiments, but are not intended to limit the disclosure. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Meanwhile, elements in the drawings described in the disclosure are independently drawn for the purpose of convenience for explanation of different specific functions, and do not mean that the elements are embodied by independent hardware or independent software. For example, two or more elements of the elements may be combined to form a single element, or one element may be divided into plural elements. The embodiments in which the elements are combined and/or divided belong to the disclosure without departing from the concept of the disclosure.

Hereinafter, embodiments of the present disclosure will be described in detail with reference to the accompanying drawings. In addition, like reference numerals are used to indicate like elements throughout the drawings, and the same descriptions on the like elements will be omitted.

In the present specification, generally a picture means a unit representing an image at a specific time, a slice is a unit constituting a part of the picture. One picture may be composed of plural slices, and the terms of a picture and a slice may be used in place of each other as circumstances demand.

A pixel or a pel may mean a minimum unit constituting one picture (or image). Further, a “sample” may be used as a term corresponding to a pixel. The sample may generally represent a pixel or a value of a pixel, may represent only a pixel (a pixel value) of a luma component, and may represent only a pixel (a pixel value) of a chroma component.

A unit indicates a basic unit of image processing. The unit may include at least one of a specific area and information related to the area. Optionally, the unit may be mixed with terms such as a block, an area, or the like. In a typical case, an M′N block may represent a set of samples or transform coefficients arranged in M columns and N rows.

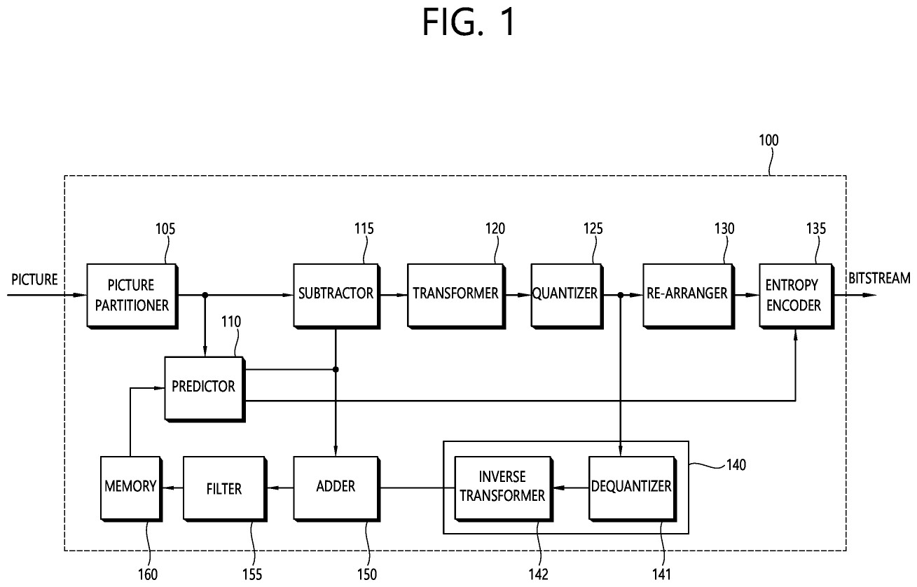

FIG. 1 is a diagram schematically describing a configuration of a video encoding apparatus to which the disclosure may be applied.

Referring to FIG. 1, a video encoding apparatus 100 may include a picture partitioner 105, a predictor 110, a subtractor 115, a transformer 120, a quantizer 125, a re-arranger 130, an entropy encoder 135, a residual processor 140, an adder 150, a filter 155, and a memory 160. The residual processor 140 may include a dequantizer 141 and an inverse transformer 142.

The picture partitioner 105 may split an input picture into at least one processing unit.

In one example, a processing unit may be called a coding unit (CU). In this case, starting with the largest coding unit (LCU), the coding unit may be recursively partitioned according to the QTBT (Quad-tree binary-tree) structure. For example, one coding unit may be divided into multiple coding units of a deeper depth based on a quad tree structure and/or a binary tree structure. In this case, for example, the quad tree structure may be applied first and the binary tree structure may be applied later. Alternatively, the binary tree structure may be applied first. The coding procedure according to the disclosure may be performed based on the last coding unit which is not further divided. In this case, based on coding efficiency according to image characteristics, the largest coding unit may be used as the last coding unit. Alternatively, if necessary, the coding unit may be recursively divided into coding units of a further deeper depth so that the coding unit of the optimal size may be used as the last coding unit. In this connection, the coding procedure may include procedures such as prediction, transform, and reconstruction, which will be described later.

As another example, a processing unit may include a coding unit (CU), a prediction unit (PU) or a transform unit (TU). The coding unit may be one of coding units of deeper depth split from a largest coding unit (LCU) according to a quad-tree structure. In this case, based on coding efficiency according to image characteristics, the largest coding unit may be used as the last coding unit. Alternatively, if necessary, the coding unit may be recursively divided into coding units of a further deeper depth so that the coding unit of the optimal size may be used as the last coding unit. When a smallest coding unit (SCU) is set, a coding unit cannot be split into a coding unit smaller than the smallest coding unit. Here, the final coding unit refers to a coding unit partitioned or split into a prediction unit or a transform unit. A prediction unit is a unit partitioned from a coding unit and may be a unit of sample prediction. Here, the prediction unit may be divided into sub-blocks. A transform unit may be split from a coding unit according to the quad-tree structure and may be a unit that derives a transform coefficient and/or a unit that derives a residual signal from a transform coefficient. Hereinafter, the coding unit may be called a coding block (CB), the prediction unit may be called a prediction block (PB), and the transform unit may be called a transform block (TB). The predicted block or the prediction unit may mean a specific region having a block shape in a picture, and may include an array of a prediction sample. Further, the transform block or the transform unit may mean a specific region having a block shape in a picture, and may include an array of a residual sample or a transform coefficient.

The predictor 110 may perform prediction on a processing target block (hereinafter, referred to as ‘current block’), and may generate a predicted block including predicted samples for the current block. A unit of prediction performed in the predictor 110 may be a coding block, or may be a transform block, or may be a prediction block.

The predictor 110 may determine whether intra prediction is applied or inter-prediction is applied to the current block. For example, the predictor 110 may determine whether the intra prediction or the inter prediction is applied in a CU unit.

In case of the intra-prediction, the predictor 110 may derive a prediction sample for a current block based on a reference sample outside the current block in a picture to which the current block belongs (hereinafter, a current picture). In this case, the predictor 110 may derive a prediction sample based on an average or interpolation of neighboring reference samples of a current block (case (i)), or may derive the prediction sample based on a reference sample existing in a specific (prediction) direction as to a prediction sample among neighboring reference samples of a current block (case (ii)). The case (i) may be called a non-directional mode or a non-angular mode, and the case (ii) may be called a directional mode or an angular mode. In the intra prediction, prediction modes may include as an example thirty three directional modes and at least two non-directional modes. The non-directional modes may include a DC prediction mode and a planar mode. The predictor 110 may determine a prediction mode to be applied to a current block by using a prediction mode applied to a neighboring block.

In case of the inter prediction, the predictor 110 may derive the prediction sample for a current block based on a sample specified by a motion vector on a reference picture. The predictor 110 may derive the prediction sample for a current block by applying any one of a skip mode, a merge mode, and a motion vector prediction (MVP) mode. In case of the skip mode and the merge mode, the predictor 110 may use motion information of a neighboring block as motion information of a current block. In case of the skip mode, unlike the merge mode, a difference (residual) between the prediction sample and an original sample is not transmitted. In the MVP mode, the motion vector of the current block can be derived using the motion vector of the neighboring block as a motion vector predictor and as a motion vector predictor of the current block.

In the case of inter prediction, the neighboring block may include a spatial neighboring block existing in the current picture and a temporal neighboring block present in the reference picture. A reference picture including the temporal neighboring block may be called a collocated picture (colPic). The motion information may include a motion vector and a reference picture index. Information such as prediction mode information and motion information may be (entropy) encoded, and then output in a form of a bitstream.

When the motion information of the temporal neighboring block is used in the skip mode and the merge mode, the highest picture on the reference picture list may be used as a reference picture. Reference pictures included in a reference picture list may be sorted based on a difference in a picture order count (POC) between a current picture and a corresponding reference picture. The POC corresponds to the display order of the pictures and may be distinguished from the coding order.

The subtractor 115 generates a residual sample which is a difference between the original sample and the prediction sample. If the skip mode is applied, the residual sample may not be generated as described above.

The transformer 120 generates a transform coefficient by transforming the residual sample in a transform block unit. The transformer 120 may perform the transform according to the size of the transform block and the prediction mode applied to the coding block or the prediction block that spatially overlaps the transform block. For example, if intra-prediction is applied to the coding block or the prediction block that overlaps the transform block, and the transform block is a 4×4 residual array, the residual sample may be transformed by using a discrete sine transform (DST). In other cases, the residual sample may be transformed by using a discrete cosine transform (DCT).

The quantizer 125 may quantize the transform coefficients to generate quantized transform coefficients.

The re-arranger 130 rearranges the quantized transform coefficients. The re-arranger 130 may rearrange the quantized transform coefficients in the form of a block into a one-dimensional vector form through a coefficient scanning method. Although the re-arranger 130 is described in a separate configuration, the re-arranger 130 may be a part of the quantizer 125.

The entropy encoder 135 may perform entropy encoding on the quantized transform coefficients. Entropy encoding may include, for example, encoding methods such as exponential Golomb, context-adaptive variable length coding (CAVLC), context-adaptive binary arithmetic coding (CABAC), and the like. The entropy encoder 135 may encode information necessary for video reconstruction other than the quantized transform coefficients (for example, a value of a syntax elements or the like) together or separately. Entropy encoded information may be transmitted or stored in network abstraction layer (NAL) units in a bitstream form.

The dequantizer 141 dequantizes the quantized values (quantized transform coefficients) in the quantizer 125, and the inverse transformer 142 inverse-transforms the dequantized values in the dequantizer 141 to generate a residual sample.

The adder 150 reconstructs a picture by combining the residual sample and the prediction sample. The residual sample and the prediction sample may be added in a block unit to generate a reconstructed block. Although the adder 150 is described in a separate configuration, the adder 150 may be a part of the predictor 110. Meanwhile, the adder 150 may be called a reconstruction unit or reconstructed block generation unit.

The filter 155 may apply a deblocking filter and/or a sample adaptive offset to the reconstructed picture. Through deblocking filtering and/or sample adaptive offset, the artifacts of the block boundaries in the reconstructed picture or the distortion in the quantization process can be corrected. The sample adaptive offset may be applied in a sample unit, and may be applied after the process of deblocking filtering is completed. The filter 155 may apply an adaptive loop filter (ALF) to the reconstructed picture. The ALF may be applied to the reconstructed picture to which deblocking filtering and/or sample adaptive offset has been applied.

The memory 160 may store information necessary for encoding/decoding or a reconstructed picture (decoded picture). Here, the reconstructed picture may be a reconstructed picture on which the filtering procedure has been completely performed by the filter 155. The stored reconstructed picture may be used as a reference picture for (inter-) prediction of other pictures. For example, the memory 160 may store (reference) pictures used for inter prediction. In this case, pictures used for inter prediction may be designated by a reference picture set or a reference picture list.

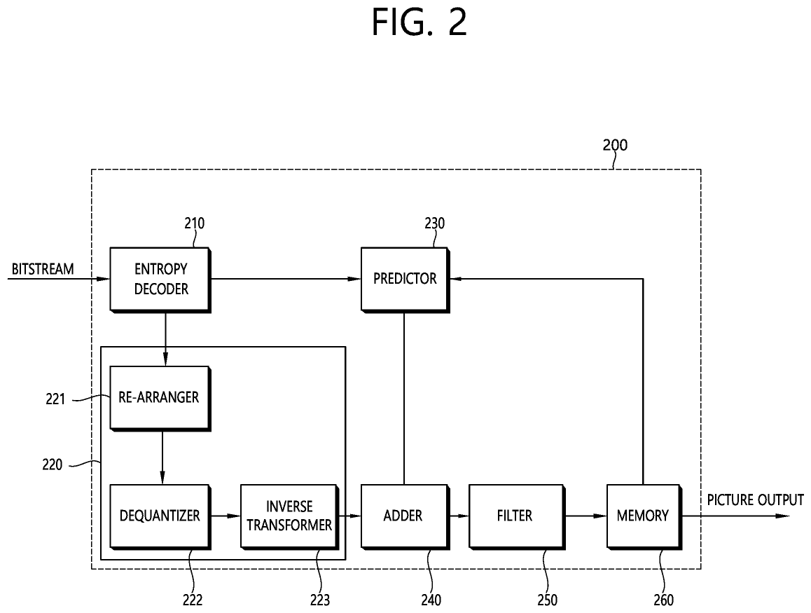

FIG. 2 is a diagram schematically describing a configuration of a video decoding apparatus to which the disclosure may be applied.

Referring to FIG. 2, the video decoding apparatus 200 may include an entropy decoder 210, a residual processor 220, a predictor 230, an adder 240, a filter 250 and a memory 260. Here, the residual processor 220 may include a re-arranger 221, a dequantizer 222 and an inverse transformer 223.

When a bitstream including video information is input, the video decoding apparatus 200 may reconstruct a video in correspondence to a process by which video information is processed in the video encoding apparatus.

For example, the video decoding apparatus 200 may perform video decoding by using processing units applied in the video encoding apparatus. Therefore, as an example, a processing unit block of video decoding may be a coding unit, or as another example, a processing unit block of video decoding may be a coding unit, a prediction unit, or a transform unit. The coding unit may be split according to a quad tree structure and/or binary tree structure from a largest coding unit.

A prediction unit or a transform unit may be further used in some cases, and in this case, the prediction block, which is a block derived or partitioned from the coding unit, may be a unit of sample prediction. In this case, the prediction unit may be divided into sub-blocks. The transform unit may be split according to the quad-tree structure, and may be a unit for deriving a transform coefficient or a unit for deriving a residual signal from the transform coefficient.

The entropy decoder 210 may parse the bitstream to output information necessary for video reconstruction or picture reconstruction. For example, the entropy decoder 210 may decode information in the bitstream based on a coding method such as exponential Golomb encoding, CAVLC, CABAC, or the like, and may output a value of a syntax element necessary for video reconstruction and a quantized value of a transform coefficient regarding a residual.

More specifically, a CABAC entropy decoding method may receive a bin corresponding to each syntax element in a bitstream, determine a context model using decoding target syntax element information and decoding information of neighboring and decoding target blocks or information of symbol/bin decoded in a previous step, predict bin generation probability according to the determined context model and perform arithmetic decoding of the bin to generate a symbol corresponding to each syntax element value. Here, the CABAC entropy decoding method may update the context model using information of a symbol/bin decoded for a context model of the next symbol/bin after determination of the context model.

Information on prediction among information decoded in the entropy decoder 210 may be provided to the predictor 230 and residual values, that is, quantized transform coefficients, on which entropy decoding has been performed by the entropy decoder 210 may be input to the re-arranger 221.

The re-arranger 221 may rearrange the quantized transform coefficients into a two-dimensional block form. The re-arranger 221 may perform rearrangement corresponding to coefficient scanning performed by the encoding apparatus. Although the re-arranger 221 is described as a separate component, the re-arranger 221 may be a part of the dequantizer 222.

The dequantizer 222 may dequantize the quantized transform coefficients based on a (de)quantization parameter to output a transform coefficient. In this case, information for deriving a quantization parameter may be signaled from the encoding apparatus.

The inverse transformer 223 may inverse-transform the transform coefficients to derive residual samples.

The predictor 230 may perform prediction on a current block, and may generate a predicted block including predicted samples for the current block. A unit of prediction performed in the predictor 230 may be a coding block or may be a transform block or may be a prediction block.

The predictor 230 may determine whether to apply intra-prediction or inter-prediction based on information on prediction. In this case, a unit for determining which one will be used between the intra-prediction and the inter-prediction may be different from a unit for generating a prediction sample. Additionally, units for generating a prediction sample in inter prediction and intra-prediction may also be different. For example, whether to apply inter prediction or intra-prediction may be determined in a CU unit. In addition, for example, in inter prediction, a prediction mode may be determined and a prediction sample may be generated in a PU unit, and in intra prediction, a prediction mode may be determined in a PU unit and a prediction sample may be generated in a TU unit.

In the case of intra-prediction, the predictor 230 may derive the prediction sample for the current block based on the neighbor reference sample in the current picture. The predictor 230 may derive the prediction sample for the current block by applying the directional mode or the non-directional mode based on the neighboring reference sample of the current block. In this case, the prediction mode to be applied to the current block may be determined using the intra-prediction mode of the neighboring block.

In the case of inter-prediction, the predictor 230 may derive the prediction sample for the current block based on the sample, specified by the motion vector, on the reference picture. The predictor 230 may derive a prediction sample for the current block by applying any one of a skip mode, a merge mode, and an MVP (Motion Vector Prediction) mode. In this case, motion information necessary for inter prediction of the current block provided by a video encoding apparatus, for example, information on a motion vector, a reference picture index, and the like may be acquired or derived based on the information on prediction.

In case of the skip mode and the merge mode, motion information of a neighboring block may be used as motion information of a current block. In this case, the neighboring block may include a spatial neighboring block and a temporal neighboring block.

The predictor 230 may construct a merge candidate list with motion information of available neighboring blocks, and may use information indicated by merge indexs in the merge candidate list as a motion vector of a current block. The merge indexs may be signaled from an encoding apparatus. The motion information may include a motion vector and a reference picture. If motion information of a temporal neighboring block is used in the skip mode and the merge mode, a highest picture on the reference picture list may be used as a reference picture.

In case of the skip mode, unlike the merge mode, a difference (residual) between the prediction sample and an original sample is not transmitted.

In the case of the MVP mode, a motion vector of a current block may be derived using a motion vector of a neighboring block as a motion vector predictor. In this case, the neighboring block may include a spatial neighboring block and a temporal neighboring block.

For example, when the merge mode is applied, a merge candidate list may be generated by using a motion vector of a reconstructed spatial neighboring block and/or a motion vector corresponding to a Col block, which is a temporal neighboring block. In the merge mode, a motion vector of a candidate block selected from the merge candidate list is used as the motion vector of the current block. The information on prediction may include a merge index indicating a candidate block having an optimal motion vector selected from candidate blocks included in the merge candidate list. In this case, the predictor 230 may derive the motion vector of the current block by using the merge index.

As another example, when the MVP mode is applied, a motion vector predictor candidate list may be generated using a motion vector of a reconstructed spatial neighboring block and/or a motion vector corresponding to a Col block, which is a temporal neighboring block. That is, a motion vector of a reconstructed spatial neighboring block and/or a motion vector corresponding to the Col vector, which is a temporal neighboring block, may be used as a motion vector candidate. The information on prediction may include a prediction motion vector index indicating an optimal motion vector selected from the motion vector candidates included in the list. In this case, the predictor 230 may select the predicted motion vector of the current block from the motion vector candidates included in the motion vector candidate list, by using the motion vector indexs. The predictor of the encoding apparatus may acquire a motion vector difference (MVD) between a motion vector of a current block and a motion vector predictor, and may encode the MVD and output the encoded MVD in a bitstream form. That is, MVD may be acquired by subtracting the motion vector predictor from the motion vector of the current block. In this case, the predictor 230 may acquire a motion vector difference included in the information on prediction, and derive the motion vector of the current block by adding the motion vector difference and the motion vector predictor. The predictor may also acquire or derive a reference picture index or the like indicating a reference picture from the information on prediction.

The adder 240 may reconstruct the current block or the current picture by adding the residual sample and the prediction sample. The adder 240 may reconstruct the current picture by adding the residual sample and the prediction sample in a block unit. Since the residual is not transmitted when the skip mode is applied, the prediction sample may be a reconstruction sample. Although the adder 240 is described in a separate configuration, the adder 240 may be a part of the predictor 230. Meanwhile, the adder 240 may be called a reconstruction unit or reconstructed block generation unit.

The filter 250 may apply the deblocking filtering sample adaptive offset, and/or ALF to the reconstructed picture. In this case, the sample adaptive offset may be applied in a sample unit and may be applied after deblocking filtering. ALF may be applied after deblocking filtering and/or sample adaptive offset.

The memory 260 may store information necessary for decoding or a reconstructed picture (decoded picture). Here, the reconstructed picture may be a reconstructed picture on which the filtering procedure has been completely performed by the filter 250. For example, the memory 260 may store pictures used for inter prediction. In this case, pictures used for inter-prediction may be designated by a reference picture set or a reference picture list. The reconstructed picture may be used as a reference picture for another picture. In addition, the memory 260 may output the reconstructed picture in an output order.

If intra prediction or inter-prediction is performed as described above, a predicted block including prediction samples for a current block may be generated. Here, the predicted block includes prediction samples in a space domain (or pixel domain). The predicted block may be indentically derived in an encoding apparatus and a decoding apparatus, and the encoding apparatus may increase image decoding efficiency by signaling to a decoding apparatus not an original sample value of an original block itself but information on residual (residual information) between the original block and the predicted block. The decoding apparatus may derive a residual block including residual samples based on the residual information, generate a reconstructed block including reconstruction samples by adding the residual block to the predicted block, and generate a reconstructed picture including reconstructed blocks. The encoding apparatus may also generate a reconstructed block to utilize as a reference picture for inter prediction by adding the residual block to the predicted block, and generate a reconstructed picture including reconstructed blocks.

Meanwhile, although various and refined prediction methods are used in a video coding system, there may occur a certain degree of difference between a predicted block and a reconstructed block. For example, in a case where intra prediction is applied, prediction samples are derived generally by copying samples from specific prediction direction and using them as prediction samples, or by using an average value of neighboring samples or a bidirectional interpolation value. Therefore, a predicted block may be similar to a reconstructed block, but there may occur a certain degree of difference from a reconstruction sample of a corresponding phase when viewed in a sample unit. Further, in a case where inter prediction is applied, predicted block is derived by using a reference block of a specific position indicated by a motion vector, and thus there may occur difference between a predicted block and a reconstructed block due to movement or rotation of an object depending on difference of time between a reference picture and a current picture. Such difference may be called noise, and increase values of residual samples and amount of bits necessary for signaling residual information. According to the disclosure, a modified predicted block may be derived through processing on a predicted block in a frequency domain, which in turn can lead to decrease in amount of bits necessary for residual information, and to improvement of general coding efficiency. The processing on a predicted block in a frequency domain according to the disclosure may be called frequency domain noise reduction (FDNR).

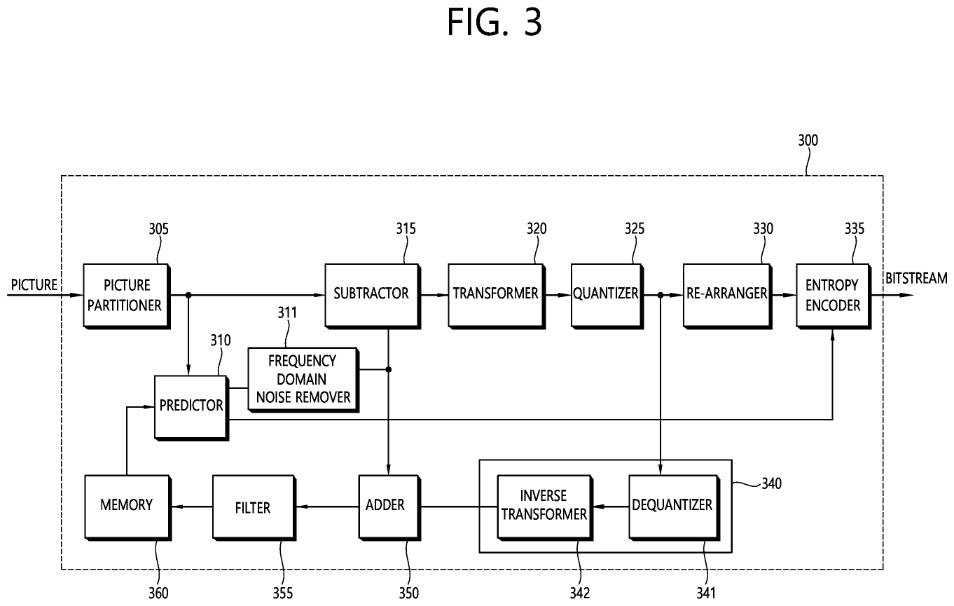

FIG. 3 is a diagram schematically describing a configuration of a video encoding apparatus according to the disclosure.

Referring to FIG. 3, a video encoding apparatus 300 may include a frequency domain noise remover 311 as well as a picture partitioner 305, a predictor 310, a subtractor 315, a transformer 320, a quantizer 325, a re-arranger 330, an entropy encoder 335, a residual processor 340, an adder 350, a filter 355 and a memory 360. The frequency domain noise remover 311 may be included in the predictor 310, or may be distinguished as a separate unit.

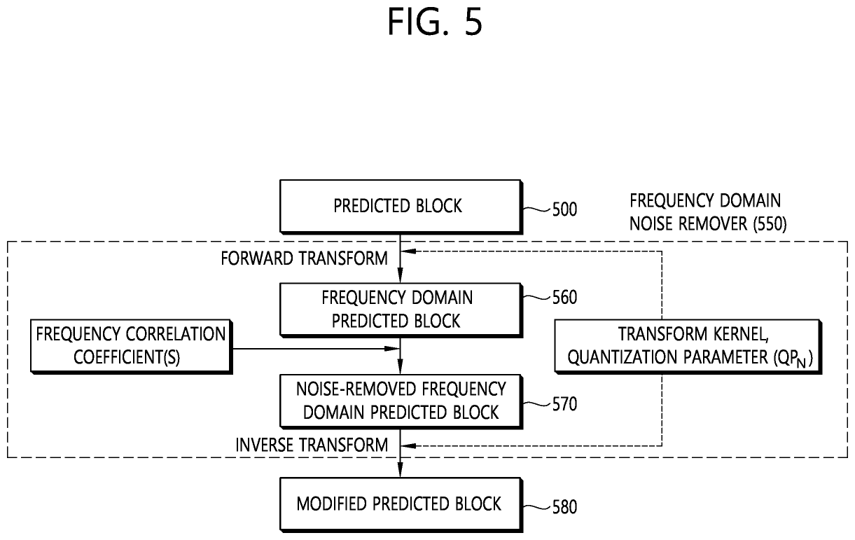

The picture partitioner 305, the predictor 310, the subtractor 315, the transformer 320, the quantizer 325, the re-arranger 330, the entropy encoder 335, the residual processor 340, the adder 350, the filter 355, and the memory 360 are as described above in FIG. 1. However, there is difference in that a predicted block generated in the predictor 310 is processed in a frequency domain noise remover 311, so that a modified predicted block is generated, and that a residual block is generated based on comparison with an original block (an original sample) by the modified predicted block being input into the subtractor 315. Specific operation of the frequency domain noise remover 311 will be described later in or after FIG. 5.

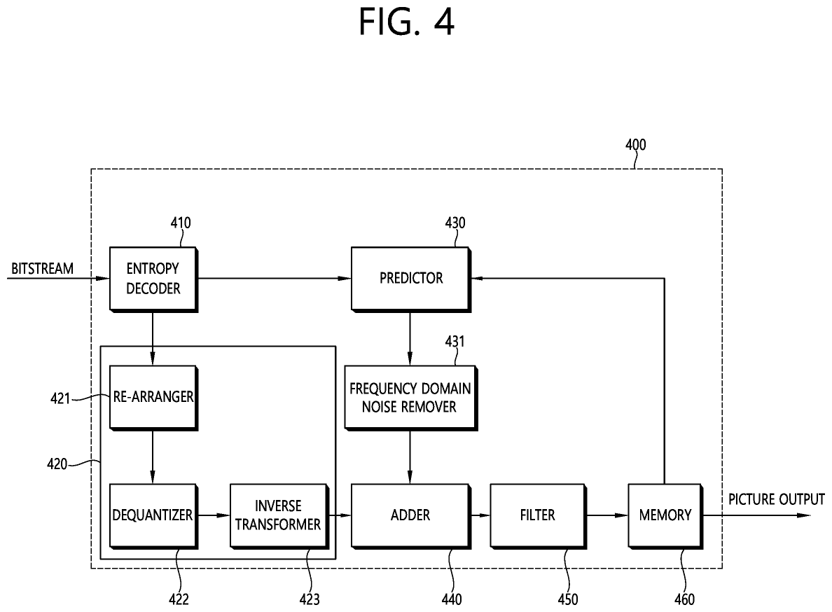

FIG. 4 is a diagram schematically describing a configuration of a video decoding apparatus according to the disclosure.

Referring to FIG. 4, a video decoding apparatus 400 may include a frequency domain noise remover 431 as well as an entropy decoder 410, a residual processor 420, a predictor 430, an adder 440, a filter 450 and a memory 460. The frequency domain noise remover 431 may be included in the predictor 430, or may be distinguished as a separate unit.

The entropy decoder 410, the residual processor 420, the predictor 430, the adder 440, the filter 450 and the memory 460 are as described above in FIG. 2. However, there is difference in that a predicted block generated in the predictor 430 is processed in a frequency domain noise remover 431, so that a modified predicted block is generated, and that a reconstructed block is generated by the modified predicted block being input into the adder 440. Specific operation of the frequency domain noise remover 431 will be described later in or after FIG. 5.

FIG. 5 schematically represents a configuration of a frequency domain noise remover according to the disclosure.

Referring to FIG. 5, the frequency domain noise remover 550 derives a frequency domain predicted block 560 by applying transform (forward transform) to the predicted block 500. In this case, the transform may be performed based on a transform kernel and/or a quantization parameter (QPN). The frequency domain predicted block 560 includes transform coefficients.

The frequency domain noise remover 550 derives a noise-removed frequency domain predicted block 570 by multiplying the transform coefficients by the frequency correlation coefficients. The noise-removed frequency domain predicted block 570 may be called a frequency domain modified predicted block. The noise-removed frequency domain predicted block 570 includes modified transform coefficients. The modified transform coefficients may be derived based on the transform coefficients and the frequency correlation coefficients. The frequency correlation coefficients may be configured in a correlation block form, and may be called a frequency correlation coefficient array. The frequency correlation coefficients may be determined in an encoding apparatus and may be signaled to a decoding apparatus. Alternatively, the frequency correlation coefficients may be predetermined according to conditions. For example, an encoding apparatus may derive the frequency correlation coefficients by which noise of the prediction block becomes smallest in terms of rate-distortion optimization (RDO). In this case, an encoding apparatus may transmit information representing the frequency correlation coefficients to a decoding apparatus, or an encoding apparatus and a decoding apparatus may predetermine frequency correlation coefficients and use them according to conditions.

The frequency domain noise remover 550 derives a modified predicted block 590 of a spatial domain by applying transform (inverse transform) to the noise-removed frequency domain predicted block 570. The modified predicted block 590 includes modified prediction samples, which may be derived by applying transform to the modified transform coefficients. In this case, the transform may be performed based on the quantization parameter (QPN) and/or the transform kernel which have/has been used in the forward transform.

Through the procedure, the modified predicted block of space domain whose noise has been reduced or removed may be derived, and after this, as in the existing coding procedure, an encoding apparatus may generate a residual block through difference between an original block and the modified predicted block, and a decoding apparatus may generate a reconstructed block and a reconstructed picture by adding the modified predicted block to a residual block derived from the received residual information. In this case, as residual energy (i.e. amount of data necessary for residual information) is reduced by effectively removing noise present in predicted block from frequency domain, image compression efficiency can be increased.

Determination of the frequency correlation coefficients and the transform kernel used in the above-described frequency domain noise reduction method according to the disclosure may be performed as below.

Frequency domain noise reduction may be performed based on transform coefficients (acquired through transform) for a predicted block and frequency correlation coefficients as described above. In this case, calculation may be done using a frequency correlation coefficient Cij corresponding to each transform coefficient and frequency position of the transform coefficient. Here, (i, j) represents horizontal and vertical components of the frequency position. A value of the frequency correlation coefficient may be inversely proportional to magnitude of noise at the frequency position. For example, if there is no noise at the frequency position, Cij may have a value of 1, and in this case, reliability of transform coefficient of the frequency position corresponds to 100% so as not to be affected during a noise reduction (or noise removal) procedure. As another example, if there is some noise at the frequency position, Cij may have a value of 0.5, and in this case, a transform coefficient of the frequency position is affected during a noise reduction procedure.

A transform coefficient Uij modified after noise reduction in a frequency domain may be derived as below.

Uᵢⱼ=Cᵢⱼ×Pᵢⱼ [Equation 1]

where Uij is a modified transform coefficient, and may be regarded as a confidence coefficient after noise removal from frequency domain. Cij is a frequency correlation coefficient. Here, Cij is between 0 and 1 inclusive. Pij represents a transform coefficient derived through transform for a prediction block. Here, i and j represent a horizontal component and a vertical component of position of the coefficient in frequency domain, respectively. A×B represents multiplication between scalar values A and B.

For example, Cij may be calculated beforehand through online or offline training before coding. In this case, for example, it may be transmitted to a decoding apparatus through a bitstream, or Cij value which has been calculated beforehand through offline training may be predefined (or stored) and used.

Meanwhile, besides the frequency correlation coefficient mentioned in Equation 1, an additional correlation coefficient may be used as weight for effective noise removal. It may be called a weight coefficient.

Uᵢⱼ=Kᵢⱼ×Cᵢⱼ×Pᵢⱼ [Equation 2]

where Kij is the weight coefficient. Kij may be predetermined or signaled. Alternatively, Kij may be determined depending on a quantization parameter (QP). Alternatively, Kij may be dependently determined according to a size of a current block and a shape of a current block (square, nonsquare).

Pij is a transform coefficient derived through transform for a prediction block, and in this case, a quantization parameter used in transform of the prediction block may be identical to or different from a quantization parameter used when encoding a residual block (residual signal). If other quantization parameter is used, value of difference from a quantization parameter used when encoding the residual signal may be transmitted in order to represent a quantization parameter used in transform of the prediction block.

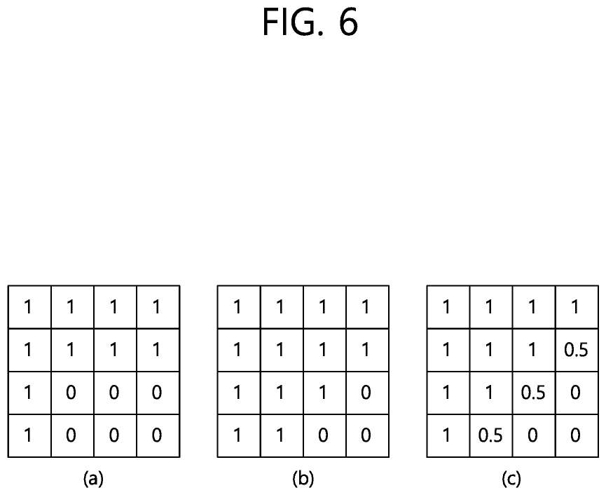

Meanwhile, Cij, a frequency coefficient, may be represented in a form of a correlation coefficient block like following FIG. 6.

FIG. 6 represents, by way of example, correlation coefficient blocks constituted by correlation coefficients. FIG. 6 illustrates correlation coefficient blocks of 4×4 size.

Referring to FIG. 6, a correlation coefficient block includes frequency correlation coefficients, which can be discriminated according to frequency positions. In this case, the frequency correlation coefficients are multiplied by corresponding transform coefficients (transform coefficients derived through transform of a prediction block) according to the frequency position, through which modified transform coefficients can be derived.

The frequency domain noise remover may use a correlation coefficient block predefined among various kinds of correlation coefficient blocks, or select and use one correlation coefficient block from them.

In one example, one correlation coefficient block predefined among multiple correlation coefficient blocks available according to characteristics of a block may be selected.

As another example, an encoding apparatus may select one among multiple correlation coefficient blocks, and may transmit information for indicating the selected correlation coefficient block (e.g., correlation coefficient index information) through a bitstream to a decoding apparatus.

Herein, for example, the characteristics of a block may include at least one of the coding type of a current block (e.g., inter prediction, intra prediction), the number of motion vectors used in prediction of a current block in a case where inter prediction is applied, a resolution of a motion vector (e.g., an integer sample unit, a half sample unit, a quarter sample unit or the like), a size or shape (e.g., square, nonsquare) of a current block, a value of quantization parameter used in coding of a current block, the application or not of skip mode, merge mode, MVP (AMVP) mode in a case where inter prediction mode is applied to a current block, and intra prediction mode (intra directional mode #0, #1, #2 . . . , intra planar mode, intra DC mode) in a case where intra prediction mode is applied to a current block.

Meanwhile, the correlation coefficient block determined through the above-mentioned procedure may be additionally updated by the weight coefficient Kij represented in Equation 2. In this case, the weight coefficient may be commonly determined as a specific value, and may be adaptively determined according to a frequency position. The weight coefficient may be determined based on the above-described characteristics of a block.

Meanwhile, in a frequency domain noise reduction method, its effect may be varied according to what kind of transform kernel is used. In the disclosure, transform kernels as below may be used.

In one example, a predefined transform kernel may be used in common. For example, transform kernels, such as DCT2, DCT5, DCT8, DST1, DST7 and the like may be used, and a predefined one of these transform kernels may be used for blocks in a current picture in common.

As another example, a transform kernel used in coding residual information associated with a current block may be used in transform of the prediction block. In this case, as the transform of the prediction block is performed taking into consideration transform characteristics for a residual block, noise reduction effect can be improved, while reducing amount of data necessary for residual information.

Further, as another example, a transform kernel may be determined taking a size of a current block (or predicted block) into consideration. In this case, for a predicted block of a specific size or more, a transform kernel of a predetermined size may remove noise from a frequency domain through a correlation coefficient block by dividing and transforming the predicted block based on transform. For example, in a case where a predicted block of a 64×64 size is derived, noise of high frequency component may be removed by dividing the predicted block into four 32×32 blocks to apply transform to each 32×32 block unit, and taking into consideration a correlation coefficient block for 32×32 block unit.

The frequency correlation coefficient may be pre-calculated through on-line or off-line traning before encoding/decoding is performed, and the values may be stored in an encoding apparatus/coding apparatus to be used.

Meanwhile, in a case where inter prediction is applied to a current block, a reference block on a reference picture is derived using a motion vector derived based on neighboring block of the current block as described above, and a predicted block using reference samples of the reference block is derived. In this case, in order to increase inter prediction performance, the motion vector (difference value between a current block and a reference block) may have a sample resolution less than or equal to an integer unit. For example, the motion vector may have a ¼ sample resolution for luma component. Therefore, by generating a ¼ unit fractional sample from an integer sample or a full sample by interpolation on a reference picture, and by selecting a reference block from a region including the fractional sample, a reference block that is more similar to a current block can be derived.

A fractional sample less than or equal to an integer unit may be generated through an interpolation filter based on an integer sample. As described above, in the case of the luma component sample (hereinafter, referred to as luma sample), a resolution of a motion vector is a ¼ fractional sample, and an encoding apparatus and a decoding apparatus may generate sample information of a unit equal to or less than an integer on a ¼ sample unit through interpolation. In order to perform interpolation for a luma sample, an 8-tap interpolation filter having different filter coefficients may be used.

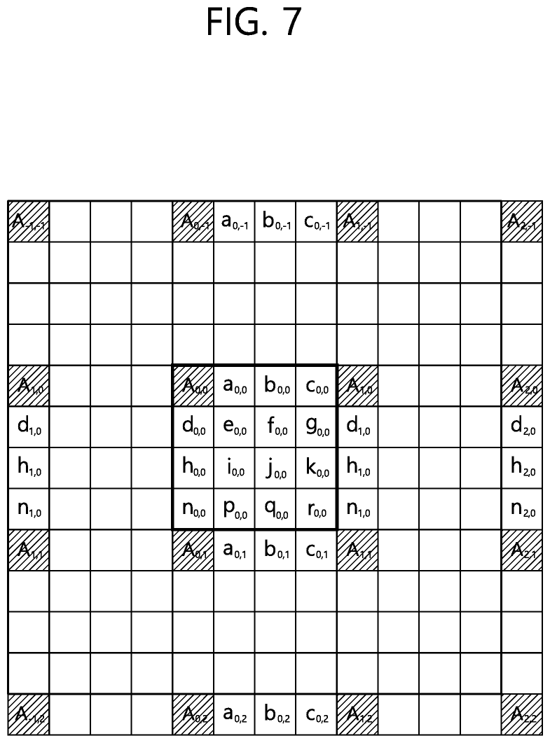

FIG. 7 is a schematic representation of positions of integer and fractional samples for ¼ fractional unit sample interpolation in inter prediction. Among the positions of the samples shown in FIG. 7, the shaded (or capital letter) position corresponds to an integer sample, while the non-shaded (or small letter) position corresponds to a fractional sample.

Table 1 below is a table which represents an example of filter coefficients according to sample position. For example, the filter coefficients may be applied to a sample of luma component.

TABLE 1

| sample position | filter coefficients |
|---|---|
| 1/4 | {−1, 4, −10, 58, 17, −5, 1, 0} |
| 2/4 | {−1, 4, −11, 40, 40, −11, 4, −1} |
| 3/4 | {0, 1, −5, 17, 58, −10, 4, −1} |

For example, the factional samples of FIG. 7 may be derived by applying an 8-tab filter based on the filter coefficient.

In a case where a motion vector of a current block has a value of a fractional sample unit like this, the frequency domain noise removal (noise reduction) method may be applied based on fractional samples derived after interpolation of integer samples of reference picture, or applied based on integer samples of the reference picture.

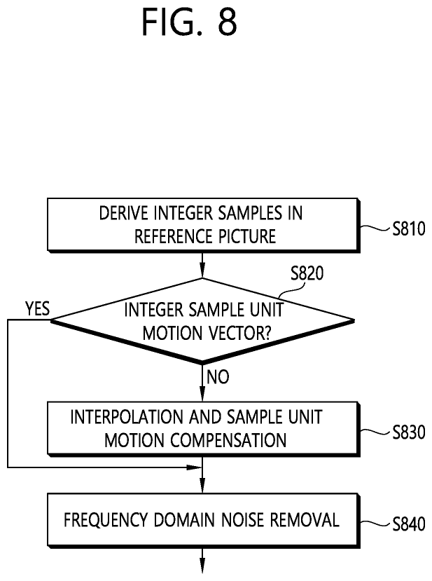

FIG. 8 represents a frequency domain interference removal (interference reduction) method based on fractional samples according to an example of the disclosure.

Referring to FIG. 8, a coding apparatus derives integer samples in a reference picture (S810). A coding apparatus may derive integer samples in a reference picture based on a motion vector of a current block. A coding apparatus may include an encoding apparatus or a decoding apparatus.

A coding apparatus checks whether the motion vector has an integer sample unit value (S820). That is, a coding apparatus checks whether a motion vector has an integer sample unit value or a fractional sample unit value.

Although S820 is described as being performed after S810 in FIG. 8, this is only an example, and S820 may be performed before S810, or performed at the same time with S810.

If the motion vector has a fractional sample unit value at S820, as described in FIG. 7 a coding apparatus derives fractional samples through an interpolation procedure using the integer samples, and performs motion compensation based on the derived fractional samples (S830). That is, a coding apparatus may derive a predicted block using the fractional samples as prediction samples of a current block.

A coding apparatus performs frequency domain noise removal on a prediction block derived using the fractional samples (S840).

If the motion vector has an integer sample unit value at S820, a coding apparatus may derive a predicted block based on the integer samples, and, as described above, may perform frequency domain noise removal.

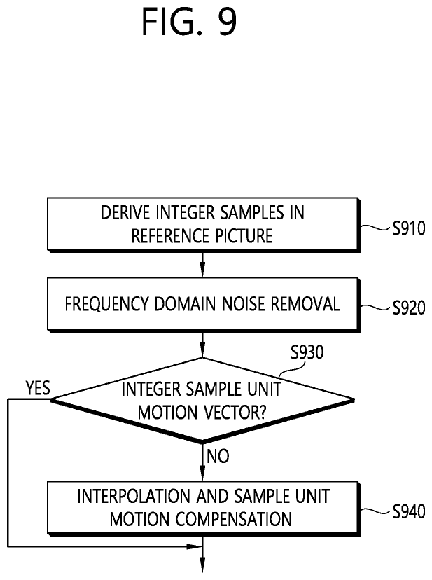

FIG. 9 represents a frequency domain interference removal (interference reduction) method based on integer samples according to an example of the disclosure.

Referring to FIG. 9, a coding apparatus derives integer samples in a reference picture (S910). A coding apparatus may derive integer samples in a reference picture based on a motion vector of a current block. A coding apparatus may include an encoding apparatus or a decoding apparatus.

A coding apparatus first performs frequency domain noise removal based on the integer samples (S920). In this case, a coding apparatus may derive (temporal) prediction samples based on the integer samples, and may derive (temporal) predicted block including the (temporal) prediction samples. A coding apparatus may perform the above-described frequency domain noise removal for the (temporal) predicted block. In this case, modified integer samples may be derived.

A coding apparatus checks whether the motion vector has an integer sample unit value (S930). That is, a coding apparatus checks whether a motion vector has an integer sample unit value or a fractional sample unit value.

Although S930 is described as being performed after S910 in FIG. 9, this is only an example, and S930 may be performed before S910, or performed at the same time with S910.

If the motion vector has a fractional sample unit value at S930, a coding apparatus derives fractional samples through an interpolation procedure using the modified integer samples, and performs motion compensation based on the derived fractional samples (S930). That is, a coding apparatus may derive a modified predicted block using the fractional samples as prediction samples of a current block.

If the motion vector has an integer sample unit value at S930, a coding apparatus may derive a predicted block based on the integer samples, and, as described above, may perform frequency domain noise removal.

According to an embodiment shown in FIG. 8, in a case where a motion vector of a current block has a fractional sample unit value, frequency domain noise removal is applied after deriving fractional samples on a reference picture. In contrast, according to an embodiment shown in FIG. 9, in a case where a motion vector of a current block has a fractional sample unit value, frequency domain noise removal is first performed for integer samples, and interpolation is performed using noise-removed (modified) integer samples, which can lead to increase in prediction efficiency. As described in FIG. 7, multiple integer samples are interpolated based on filter coefficient to derive one fractional sample in the interpolation procedure, and thus noise in some integer samples may be spread to multiple fractional samples. However, in a case where frequency domain noise removal is performed before interpolation as in the embodiment, it is possible to prevent the spread of noise and increase the prediction efficiency.

Meanwhile, the embodiment may be performed in a case where bi-prediction is applied. In a case where inter prediction is applied to a current block as described above, motion information for the inter prediction may be derived. The motion information may include LO motion information for a L0 direction and/or L1 motion information for a L1 direction. Here, the L0 motion information may include a motion vector L0 (MVL0) and an L0 reference picture index indicating an L0 reference picture included in a reference picture list L0 for the current block, and the L1 motion information may include MVL1 and an L1 reference picture index indicating L1 reference picture included in a reference picture list L1 for the current block. Here, the L0 direction may called a past direction or a forward direction. In addition, the L1 direction may be called a further direction or a backward direction. Further, the reference picture list L0 may include pictures earlier than the current picture in output order, and the reference picture list L1 may include pictures later than the current picture in output order. Alternatively, in some cases, a reference picture list L0 may further include subsequent pictures in output order, and a reference picture list L1 may further include earlier pictures in output order. Here, the output order may correspond to picture order count (POC).

In the prediction performance on a current block, if the inter prediction is performed based on L0 motion information, it may be called L0 prediction, while, if the inter prediction is performed based on L1 motion information, it may be called L1 prediction. And, if the inter prediction is performed based on the L0 motion information and the L1 motion information, it may be called bi-prediction.

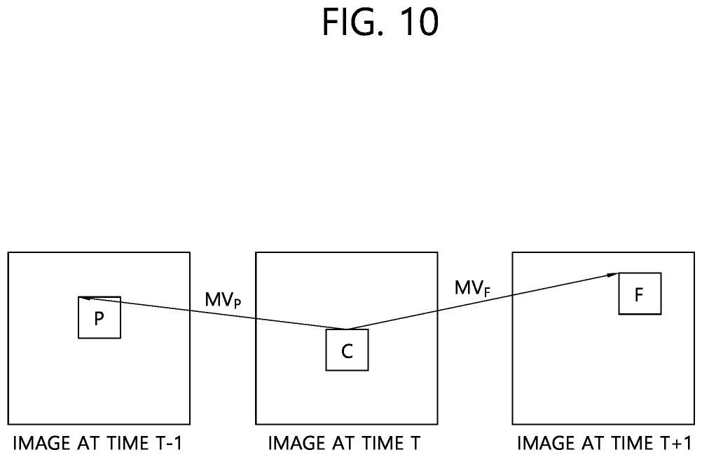

FIG. 10 represents motion vectors and reference pictures for inter prediction of the current block.

Referring to FIG. 10, in a case where inter prediction is performed on the current block, in particular, in a case where bi-prediction is performed on the current block, a decoding apparatus may derive an L0 reference block based on the L0 motion information, and may derive an L1 reference block based on the L1 motion information. Here, an image at time t−1 corresponds to the L0 reference picture, and the image at time t+1 corresponds to the L1 reference picture. MV_{P} corresponds to the L0 motion vector, and MV_{F} corresponds to the L1 motion vector.

A coding apparatus may generate a prediction sample of the current block using a mean value of L0 reference sample of the L0 reference block and L1 reference sample of the L1 reference block corresponding to the L0 reference sample. That is, a coding apparatus may derive the L0 reference sample based on the L0 motion information, may derive the L1 reference sample based on the L1 motion information, and may generate the prediction sample by dividing by 2 the sum of the sample value of the L0 reference sample and the sample value of the L1 reference sample.

This may be represented as the following Equation.

Cᵢⱼ=(Pᵢⱼ+Fᵢⱼ+1)/2 [Equation 3]

where C represents a bi-predicted prediction sample; Pᵢⱼ, an L0 reference sample; and Fij, an L1 reference sample. Here, i and j represent an x component and a y component of a space domain coordinate (i, j).

In a case where bi-prediction is applied like this, frequency domain noise removal may be performed as below.

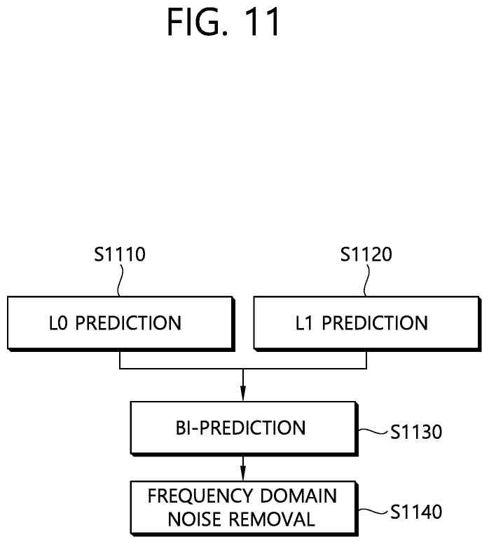

FIG. 11 represents an example of a frequency domain noise removal method in a case where bi-prediction is applied.

Referring to FIG. 11, a coding apparatus derives an L0 reference sample through L0 prediction (S1110), and derives an L1 reference sample through L1 prediction (S1120).

A coding apparatus may derive a bi-prediction-based prediction sample using the derived L0 and L1 reference samples (S1130), and may perform frequency domain noise removal on predicted block including bi-predicted prediction samples (S1140).

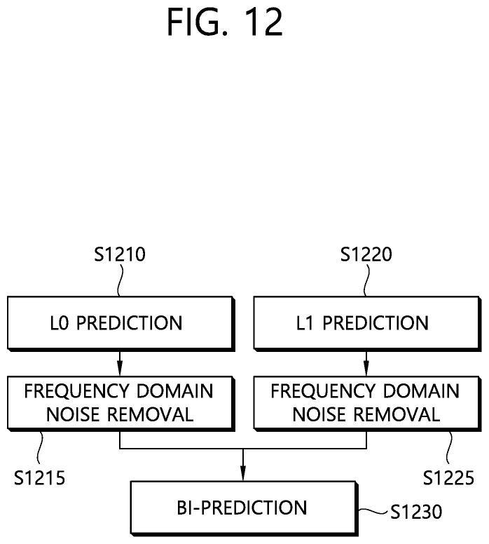

FIG. 12 represents another example of a frequency domain noise removal method in a case where bi-prediction is applied.

Referring to FIG. 12, a coding apparatus derives an L0 reference sample through L0 prediction (S1210), and derives an L1 reference sample through L1 prediction (S1220).

A coding apparatus derives a modified L0 reference sample by performing frequency domain noise removal for a L0 reference sample (S1215), and derives a modified L1 reference sample by performing frequency domain noise removal for a L1 reference sample (S1225). In this case, L0 reference samples may correspond to L0 prediction samples, and L1 reference samples may correspond to L1 prediction samples. Frequency correlation coefficient applied to the L0 reference sample may be different from frequency correlation coefficient applied to the L1 reference sample.

A coding apparatus may derive modified prediction samples by taking an average of the modified L0 reference sample and the modified L1 reference sample (S1230).

Meanwhile, a frequency domain noise removal method according to the disclosure may be applied to inter prediction which uses sub-block unit prediction. In a case where sub-block unit prediction is performed, single block may be divided into a plurality of sub-blocks, and in this case, predicted sub-blocks may be derived using motion vectors different from each other in a sub-block unit. In this case, similar to the methods set forth in FIGS. 11 and 12, frequency domain noise removal may be performed for a predicted block which is a set of predicted sub-blocks, or frequency domain noise removal may be performed respectively in a predicted sub-block unit, and modified predicted block may be derived by combining modified predicted sub-blocks. In a case where frequency domain noise removal is performed respectively in a sub-block unit, it is possible to use other frequency correlation coefficient as a predicted sub-block unit, which leads to increase in prediction performance, and it is possible to perform transform in a block unit of a smaller size, which can lead to decrease in transformation complexity.

A determination on and a signaling whether to perform frequency domain noise removal for effective coding including the frequency domain noise removal according to the above-described embodiment may be performed through a following method.

In one example, whether to perform frequency domain noise removal according to the disclosure may be indicated based on a frequency domain noise reduction (FNDR) flag. The FDNR flag may for example be signaled in a form of FNDR_flag syntax element on bitstream.

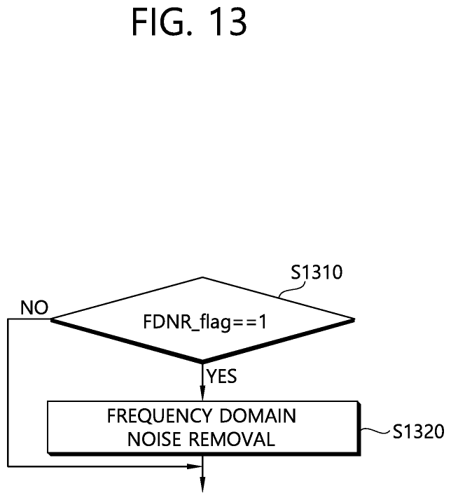

FIG. 13 represents a method for determining whether to perform frequency domain noise removal according to an example of the disclosure.

Referring to FIG. 13, a decoding apparatus checks the FDNR flag received on bitstream (S1310). If the value of the FDNR flag is 1, a decoding apparatus performs frequency domain noise removal (S1320), while, if the value of the FDNR flag is 0 (zero), a decoding apparatus does not perform frequency domain noise removal. In this case, predicted samples included in a predicted block may be derived as final prediction samples. A decoding apparatus may regard the value of the FDNR flag as 0 in a case where the FDNR flag does not exist. The FDNR flag may be signaled at a CU(CB) level. For example, the FNDR_flag syntax element may be signaled while being contained in a CU syntax.

Meanwhile, although not shown, a flag representing whether FNDR is enable at an upper level may be additionally signaled. It may be called an FDNR enable flag, and may be signaled at, for example, VPS (video parameter set), SPS (sequence parameter set), PPS (picture parameter set) and slice header levels. The FDNR flag may be signaled only if the value of the FDNR enable flag is 1. A decoding apparatus first checks (parses) an FDNR enable flag, and if the value of the FDNR enable flag is 1, the FDNR flag may be checked (parsed). If the value of the FDNR enable flag is 0, the FDNR flag may not be signaled. Even when FDNR is enable to a current picture, it may be determined adaptively whether to apply FDNR in a block unit based on hierarchical signaling structure like this, and by indicating that FDNR is not enable to one or a plurality of pictures based on one FDNR enable flag, a bit number for transmission of a block unit FDNR flag may be reduced. Through this, signaling efficiency may be increased.

As another example, it may be determined based on predefined conditions whether to perform frequency domain noise removal according to the disclosure.

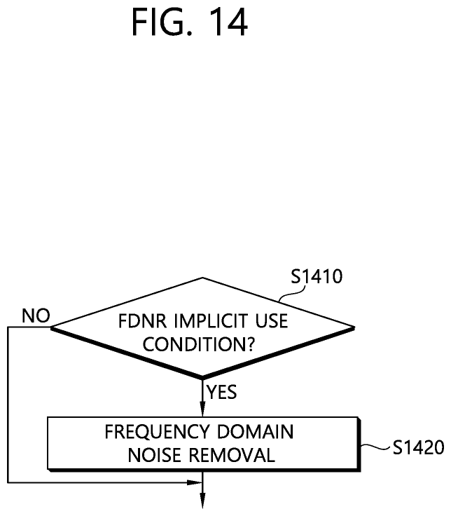

FIG. 14 represents a method for determining whether to perform frequency domain noise removal according to another example of the disclosure.

Referring to FIG. 14, a decoding apparatus determines based on predefined conditions whether to perform frequency domain noise removal (S1410). A decoding apparatus may perform frequency domain noise removal if the predefined conditions are satisfied (S1420).

The predefined conditions may be defined based on the following items:
a size and a shape (square, nonsquare) of the block. For example, if the size of a block is less than or equal to a certain size or the shape is nonsquare, the frequency domain noise removal may not be performed;
values and/or the number of non-zero coefficients in the block (here, the non-zero coefficient may mean a transform coefficient in a frequency domain predicted block after forward transform of a predicted block. For example, if there are only DC coefficients in the frequency domain predicted block and AC coefficients are all 0, the frequency domain noise removal may not be performed;
the number of motion vectors used in inter prediction of the block (that is, whether the bi-prediction is applied);
a resolution of a motion vector (integer sample unit, ½ sample unit, ¼ sample unit, ⅛ sample unit);
a color component of the block (Y, Cb, Cr),
a quantization parameter of the block;
residual information on the block (the number and/or positions of non-zero coefficients among transform coefficients for residual samples);
coding mode (inter prediction, intra prediction) of the block;
an intra prediction mode if intra prediction is applied to the block (directional prediction mode # n, planar mode, DC mode);
an inter prediction mode if inter prediction is applied to the block (skip mode, merge mode, AMVP mode), or a size of a motion vector difference (MVD) if an AMVP mode is applied; and
characteristics of a sample value of a reference block used in inter prediction (distribution, energy distribution, sobel operation difference between a chroma component and a luma component, and the like).

As another example, it may be determined by the combination of the explicit method disclosed in FIG. 13 and the implicit method disclosed in FIG. 14 whether to perform frequency domain noise removal according to the disclosure.

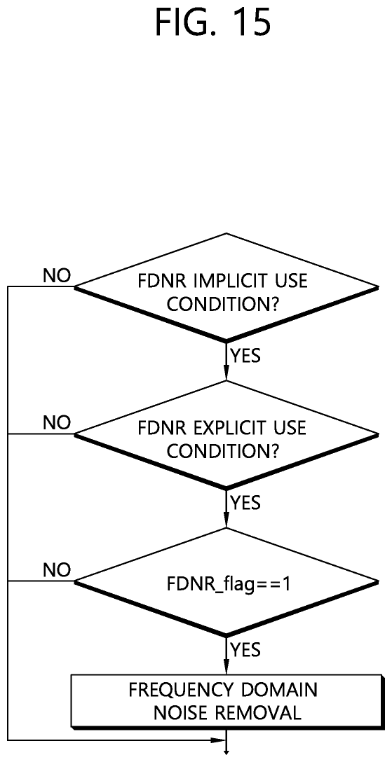

FIG. 15 represents a method for determining whether to perform frequency domain noise removal according to still another example of the disclosure.

Referring to FIG. 15, only if implicit conditions are satisfied, a decoding apparatus may receive an explicit FDNR flag, and may determine based on an explicit FDNR flag whether to perform frequency domain noise removal. Here, implicit conditions are as above-described in FIG. 14.

Frequency domain noise removal method including determination of whether to perform frequency domain noise removal according to the disclosure may be performed as below.

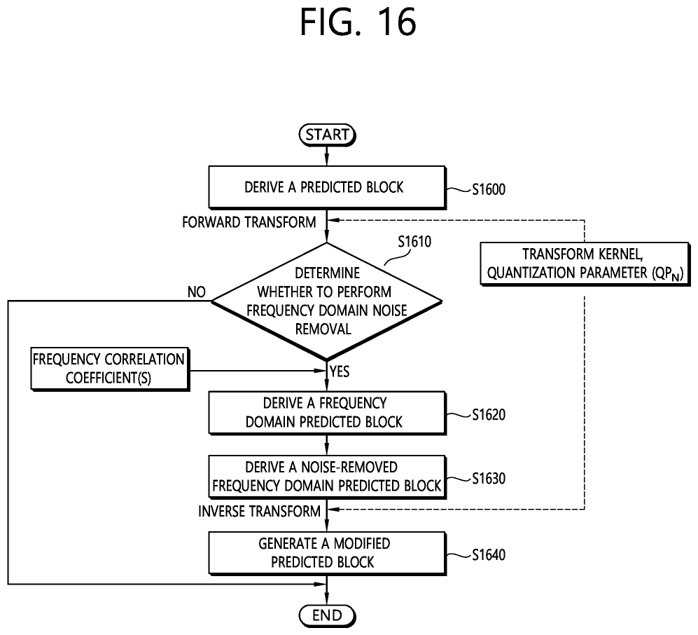

FIG. 16 represents an example of frequency domain noise removal method according to the disclosure.

Referring to FIG. 16, a coding apparatus derives a predicted block for a current block (S1600), and determines whether to perform frequency domain noise removal on the predicted block (S1610). The method of determining whether to perform frequency domain noise removal may include methods above-described in FIGS. 13 to 15. Although S1610 is described as being performed after S1600 in FIG. 16, S1610 may be performed before S1600. For example, if whether to perform the frequency domain noise removal is determined based on explicit flag information or characteristics of a current block (block size, prediction mode, shape and the like), said S1610 may be performed before S1600.

If it is determined to perform the frequency domain noise removal in S1610, a coding apparatus derives a frequency domain predicted block by applying transform (forward transform) to a derived predicted block (S1620). In this case, the transform may be performed based on a transform kernel and/or a quantization parameter (QP_{N}). The frequency domain predicted block includes transform coefficients for prediction samples.

Meanwhile, although S1610 is described as being performed after S1600 in FIG. 16, S1610 may be performed after S1620. That is, whether to perform the frequency domain noise removal may be determined after the procedure of S1620. For example, determining whether to perform frequency domain noise removal on the predicted block as described above may be based on values, the number and/or distribution of non-zero transform coefficients among the transform coefficients of the frequency domain predicted block derived at the time of frequency transform of the predicted block, and in view of such case, said S1610 may be performed after S1620. In this case, procedures in and after S1630 may be performed if it is determined in S1610 that the frequency domain noise removal is performed.

Meanwhile, if whether to perform the frequency domain noise removal becomes two steps (e.g., a first step: explicit determination, a second step: implicit determination), the procedure of S1610 may be performed stepwisely. For example, an explicit first step based on signaled flag information may be performed before or after S1610, and an implicit second step based on block characteristics may be performed before S1620. Specifically, for example, first, an explicit first step determination is performed based on an FDNR flag, and if the value of FDNR flag is 1, an implicit second step determination may be performed based on block characteristics (e.g., values, the number and/or distribution of non-zero transform coefficients) after performing S1620.

A coding apparatus derives noise-removed frequency domain predicted block by multiplying the transform coefficients by frequency correlation coefficients (S1630). The noise-removed frequency domain predicted block may be called a frequency domain modified predicted block. The noise-removed frequency domain predicted block includes modified transform coefficients. The modified transform coefficients may be derived based on the transform coefficients and the frequency correlation coefficients. The frequency correlation coefficients may be configured in a correlation block form, and may be called a frequency correlation coefficient array. The frequency correlation coefficients may be determined in an encoding apparatus and may be signaled to a decoding apparatus. Alternatively, the frequency correlation coefficients may be predetermined according to characteristics of the block as described above.

A coding apparatus derives a modified predicted block of space domain by applying transform (inverse transform) to the noise-removed frequency domain predicted block (S1640). The modified predicted block includes modified prediction samples, which may be derived by applying transform to the modified transform coefficients. In this case, the transform may be performed based on the quantization parameter (QP_{N}) and/or the transform kernel which have/has been used in the forward transform.

Through the procedure, the modified predicted block of space domain whose noise has been reduced or removed may be derived, and after this, as in the existing coding procedure, an encoding apparatus may generate a residual block through difference between an original block and the modified predicted block, and a decoding apparatus may generate a reconstructed block and a reconstructed picture by adding the modified predicted block to a residual block derived from the received residual information.

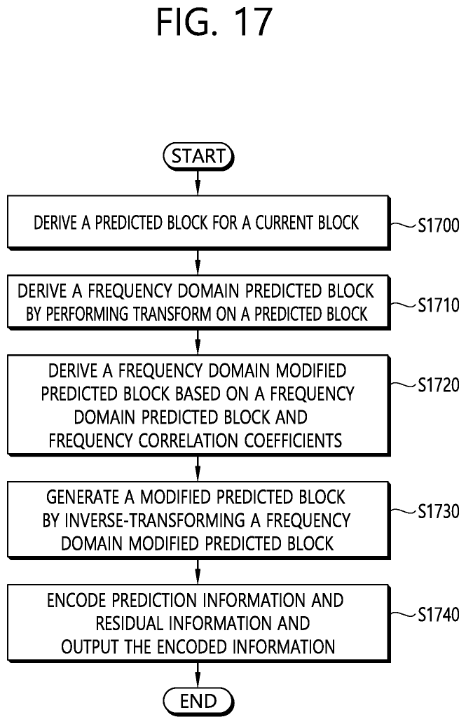

FIG. 17 schematically represents an image encoding method by an encoding apparatus according to the disclosure. The method disclosed in FIG. 17 may be performed by the encoding apparatus disclosed in FIG. 3. Specifically, for example, S1700 in FIG. 17 may be performed by the predictor of the encoding apparatus; S1710 to S1730, by the frequency domain noise remover of the encoding apparatus; and S1740, by the entropy encoder of the encoding apparatus.

An encoding apparatus derives a predicted block for a current block (S1700). A predicted block includes predicted samples for a current block.

An encoding apparatus may determine prediction mode for the current block, and may derive the predicted block according to the determined prediction mode. An encoding apparatus may determine which prediction method, for example, among intra prediction and inter prediction is applied, and may determine a specific intra prediction mode (e.g., directional intra mode # n, planar mode, DC mode) if the intra prediction is applied. Further, if the inter prediction is applied, an encoding apparatus may determine a specific inter prediction mode (e.g., skip mode, merge mode, AMVP mode). In this case, an encoding apparatus may determine an optimal prediction mode for the current block based on RDO.

An encoding apparatus performs transform on the predicted block to derive frequency domain predicted block (S1710).

First, an encoding apparatus may determine whether frequency domain noise removal (noise reduction) is applied to the current block, and, if the frequency domain noise removal is applied, it may perform transform on the predicted block to derive the frequency domain predicted block. Whether the frequency domain noise removal is applied may be determined by methods above-described in FIGS. 13 to 15.

For example, if an encoding apparatus has better RDO than in a case where the frequency domain noise removal is performed to the current block, it may determine that the frequency domain noise removal is applied to the current block, and may set an FDNR flag as 1 and signal it. As described above, an encoding apparatus may hierarchically set an FDNR enable flag at an upper level, and may set an FDNR flag by a block unit. The FDNR enable flag may be transmitted on VPS (video parameter set), SPS (sequence parameter set), PPS (picture parameter set) or a slice header. An encoding apparatus may determine whether the frequency domain noise removal is applied to a current block based on characteristics of the current block as described in FIG. 14.

If the frequency domain noise removal is applied to the current block, an encoding apparatus derives a frequency domain predicted block by applying transform (forward transform) to a predicted block. In this case, the transform may be performed based on a transform kernel and/or a quantization parameter (QP_{N}). The frequency domain predicted block includes transform coefficients derived through transform on prediction samples.

An encoding apparatus derives a frequency domain modified predicted block based on the frequency domain predicted block and frequency correlation coefficients (S1720). An encoding apparatus may derive a frequency domain modified predicted block by multiplying the transform coefficients by frequency correlation coefficients. The frequency domain modified predicted block includes modified transform coefficients. The modified transform coefficients may be derived based on the transform coefficients and the frequency correlation coefficients. The frequency correlation coefficients may be configured in a correlation block form, and may be called a frequency correlation coefficient array. The frequency correlation coefficients may be determined in an encoding apparatus and may be signaled to a decoding apparatus. Alternatively, the frequency correlation coefficients may be predetermined according to characteristics of the block as described above.

An encoding apparatus generates a modified predicted block by inverse-transforming the frequency domain modified predicted block (S1730). The modified predicted block includes modified prediction samples, which may be derived by applying transform to the modified transform coefficients. In this case, inverse transform may be performed based on the quantization parameter (QP_{N}) and/or the transform kernel which have/has been used in the forward transform.

An encoding apparatus may derive a residual block including residual samples based on differential between an original block and the modified prediction block. An encoding apparatus may generate residual information by applying transform and quantization to the residual block. The residual information represents quantized transform coefficients, and the quantized transform coefficients may be derived by quantizing transform coefficients derived by applying transform to the residual block.

Here, the transform applied to the predicted block and the transform applied to the residual block may use same transform kernel.

An encoding apparatus may derive a reconstruction sample based on a modified prediction sample included in the modified predicted block and a residual sample included in the residual block. That is, an encoding apparatus may derive the reconstruction sample by adding the modified prediction sample to the residual sample.

An encoding apparatus encodes residual information and prediction information on the current block and outputs the encoded information (S1740). The prediction information may include information on a prediction mode applied to the current block and, if inter prediction is applied to the current block, information and the like indicating motion information of the current block.

An encoding apparatus may encode the prediction information and the residual information and output the encoded information in a bitstream form. The bitstream may be transmitted to a decoding apparatus through a network or a storage medium while conveying image information necessary for decoding a current picture. Meanwhile, an encoding apparatus may encode an FNDR flag and/or an FNDR enable flag, and output the encoded flag(s) in the bitstream form. In this case, the image information may include the FDNR flag and/or the FDNR enable flag.

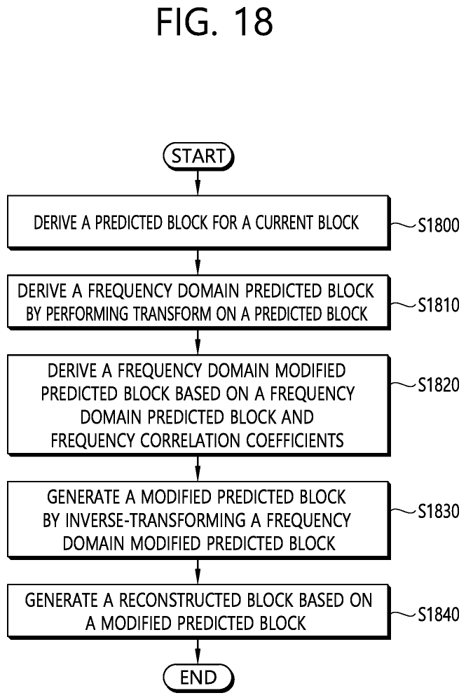

FIG. 18 schematically represents an image decoding method by a decoding apparatus according to the disclosure. The method disclosed in FIG. 18 may be performed by the decoding apparatus disclosed in FIG. 4. Specifically, for example, S1800 may be performed by the predictor of the decoding apparatus; S1810 to S1830, by the frequency domain noise remover of the decoding apparatus; and S1840, by the reconstruction unit of the decoding apparatus.

A decoding apparatus derives a predicted block for a current block (S1800). A predicted block includes predicted samples for a current block.

A decoding apparatus may derive the predicted block based on image information acquired from a bitstream. The image information may include prediction information on the current block, which may include information on a prediction mode applied to the current block and, if inter prediction is applied to the current block, information and the like indicating motion information of the current block.

A decoding apparatus performs transform on the predicted block to derive frequency domain predicted block (S1810).

First, a decoding apparatus may determine whether frequency domain noise removal (noise reduction) is applied to the current block, and, if the frequency domain noise removal is applied, it may perform transform on the predicted block to derive the frequency domain predicted block. Whether the frequency domain noise removal is applied may be determined by methods above-described in FIGS. 13 to 15.

For example, the image information may include at least one of an FDNR flag and the FDNR enable flag. If the value of the FDNR flag for the current block is 1, a decoding apparatus may determine that frequency domain noise removal is applied to the current block, and may transform the predicted block to derive the frequency domain predicted block. The FDNR enable flag may be received through VPS (video parameter set), SPS (sequence parameter set), PPS (picture parameter set) or a slice header, and, if the value of the FDNR flag is 1, the FDNR flag may be included in the image information. A decoding apparatus may determine whether the frequency domain noise removal is applied to a current block based on characteristics of the current block as described in FIG. 14.

If the frequency domain noise removal is applied to the current block, an encoding apparatus derives a frequency domain predicted block by applying transform (forward transform) to a predicted block. In this case, the transform may be performed based on a transform kernel and/or a quantization parameter (QP_{N}). The frequency domain predicted block includes transform coefficients derived through transform on prediction samples.

For example, if the prediction mode for the current block is an inter prediction mode, a decoding apparatus may derive a motion vector of the current block based on a neighboring block of the current block, and may derive the predicted block based on the motion vector. If the motion vector has a value of a fractional sample unit, the predicted block may include integer samples in a reference picture, and prediction samples derived using fractional sample unit reference samples derived based on the motion vectors. In this case, transform on the predicted block may be applied to prediction samples derived using the fractional sample unit reference samples. Alternatively, if the motion vector has a value of a fractional sample unit, prediction samples included in the predicted block may correspond to integer samples in the reference picture, and transform on the predicted block may be applied to integer samples in a reference picture.

As another example, the prediction mode for the current block is an inter prediction mode, and, if the bi-prediction is applied to the current block, a decoding apparatus may derive L0 and L1 motion vectors of the current block based on at least one neighboring block of the current block, and derive an L0 reference block based on the L0 motion vector, and an L1 reference block based on the L1 motion vector to derive the predicted block based on the L0 and L1 reference blocks. In this case, when transforming the predicted block, the transform may be performed on prediction samples included in the predicted block, which may be derived through averaging of L0 reference sample in the L0 reference block and L1 reference sample in the L1 reference block. Alternatively, if bi-prediction is applied to the current block, the predicted block on which the transform is performed may correspond to an L0 reference block derived based on the L0 motion vector or an L1 reference block derived based on the L1 motion vector.

A decoding apparatus derives a frequency domain modified predicted block based on the frequency domain predicted block and frequency correlation coefficients (S1820). A decoding apparatus may derive a frequency domain modified predicted block by multiplying the transform coefficients by frequency correlation coefficients. The frequency domain modified predicted block includes modified transform coefficients. The modified transform coefficients may be derived based on the transform coefficients and the frequency correlation coefficients. The frequency correlation coefficients may be configured in a correlation block form, and may be called a frequency correlation coefficient array. The frequency correlation coefficients may be determined in an encoding apparatus and may be signaled to a decoding apparatus. Alternatively, the frequency correlation coefficients may be predetermined according to characteristics of the block as described above.

Specifically, for example, the image information may include frequency correlation coefficient information, and a decoding apparatus may derive the frequency correlation coefficients based on the frequency correlation coefficient information. In this case, multiple frequency correlation coefficient sets are predefined, and each of the frequency correlation coefficient sets includes frequency correlation coefficients, and the frequency correlation coefficient information may indicate one of the multiple frequency correlation coefficient sets.

A decoding apparatus generates a modified predicted block by inverse-transforming the frequency domain modified predicted block (S1830). The modified predicted block includes modified prediction samples, which may be derived by applying transform to the modified transform coefficients. In this case, inverse transform may be performed based on the quantization parameter (QP_{N}) and/or the transform kernel which have/has been used in the forward transform.

A decoding apparatus may derive a residual block for the current block based on residual information. A decoding apparatus may derive transform coefficients quantized based on the residual information, and derive transform coefficients by dequantizing the quantized transform coefficients. A decoding apparatus may derive the residual block including residual samples derived by transforming the transform coefficients. In this case, the transform applied to the predicted block and the transform applied to the transform coefficients may use same transform kernel.

A decoding apparatus may generate a reconstructed block based on the modified predicted block and the residual block, and reconstruct a current picture.

After this, as described above, a decoding apparatus may apply an in-loop filtering procedure, such as deblocking filtering and/or an SAO procedure, in order to improve subjective/objective video quality as circumstances demand.

The foregoing methods according to the disclosure may be implemented as a software form, and an encoding apparatus and/or decoding apparatus according to the disclosure may be included in a device for image processing, for example, a TV, a computer, a smartphone, a set-top box, and a display device.

When embodiments in the disclosure are embodied by a software, the forgoing methods may be embodied with modules of performing above-described functions. When embodiments of the disclosure are implemented as software, the foregoing methods may be implemented as modules (processes or functions) to perform the foregoing functions. The modules may be stored in a memory and may be executed by a processor. The memory may be inside or outside the processor and may be connected to the processor via a well-known device. The processor may include an application-specific integrated circuit (ASIC), a different chipset, a logic circuit, and/or a data processor. The memory may include a read-only memory (ROM), a random access memory (RAM), a flash memory, a memory card, a storage medium, and/or another storage device.

What is claimed is:

1. An image encoding method performed by an encoding apparatus, the method comprising:
determining a prediction mode for a current block;
deriving a predicted block for the current block based on the prediction mode;
deriving a frequency domain predicted block by transforming the predicted block;
deriving a frequency domain modified predicted block based on the frequency domain predicted block and the frequency correlation coefficients;
generating a modified predicted block by inverse-transforming the frequency domain modified predicted block;
deriving a residual block based on an original block for the current block and the modified predicted block; and
encoding and outputting information on the prediction mode and residual information for the residual block.

2. The image encoding method of claim 1, wherein the residual information represents quantized transform coefficients,
the quantized transform coefficients are derived by quantizing transform coefficients derived by applying transform to the residual block, and
the transform applied to the predicted block and the transform applied to the residual block use same transform kernel.

3. An image decoding method performed by a decoding apparatus, the method comprising:
receiving image information including prediction information and residual information;
deriving a prediction mode for a current block based on the prediction information;
deriving a predicted block for the current block based on the prediction mode;
deriving a frequency domain predicted block by transforming the predicted block;
deriving a frequency domain modified predicted block based on the frequency domain predicted block and the frequency correlation coefficients;
generating a modified predicted block by inverse-transforming the frequency domain modified predicted block;
deriving a residual block based on the residual information; and
generating a reconstructed block based on the modified predicted block and the residual block.

4. The image decoding method of claim 3, wherein the image information includes frequency correlation coefficient information, and
the frequency correlation coefficients are derived based on the frequency correlation coefficient information.

5. The image decoding method of claim 4, wherein multiple frequency correlation coefficient sets are predefined, and each of the frequency correlation coefficient sets includes frequency correlation coefficients, and
the frequency correlation coefficient information indicates one of the multiple frequency correlation coefficient sets.

6. The image decoding method of claim 3, wherein the deriving of a residual block includes
deriving quantized transform coefficients based on the residual information;
deriving transform coefficients by dequantizing the quantized transform coefficients; and
deriving the residual block including residual samples derived by transforming the transform coefficients, and
wherein the transform applied to the predicted block and the transform applied to the transform coefficients use same transform kernel.

7. The image decoding method of claim 3, wherein the prediction mode for the current block is an inter prediction mode,
the driving of a predicted block includes:
driving a motion vector of the current block based on a neighboring block of the current block; and
driving the predicted block based on the motion vector,
if the motion vector has a value of a fractional sample unit, the predicted block includes integer samples in a reference picture, and prediction samples derived using fractional sample unit reference samples derived based on the motion vectors, and
the transform on the predicted block is applied to the prediction samples derived using the fractional sample unit reference samples.

8. The image decoding method of claim 3, wherein the prediction mode for the current block is an inter prediction mode,
the driving of a predicted block includes:
driving a motion vector of the current block based on a neighboring block of the current block; and
driving the predicted block based on the motion vector, and
if the motion vector has a value of a fractional sample unit, transform on the predicted block is applied to integer samples in a reference picture.

9. The image decoding method of claim 3, wherein the prediction mode for the current block is an inter prediction mode,
if bi-prediction is applied to the current block, the driving of a predicted block includes:
driving L0 and L1 motion vectors of the current block based on at least one neighboring block of the current block;
driving an L0 reference block based on the L0 motion vector;
driving an L1 reference block based on the L1 motion vector; and
driving the predicted block based on the L0 and L1 reference blocks, and
when transforming the predicted block, the transform is performed on prediction samples included in the predicted block, which are derived through averaging of L0 reference sample in the L0 reference block and L1 reference sample in the L1 reference block.

10. The image decoding method of claim 3, wherein the prediction mode for the current block is an inter prediction mode, and
if bi-prediction is applied to the current block, the predicted block on which the transform is performed corresponds to an L0 reference block derived based on the L0 motion vector or an L1 reference block derived based on the L1 motion vector.

11. The image decoding method of claim 3, wherein the image information includes a frequency domain noise reduction (FDNR) flag, and
if a value of the FDNR flag is 1, the frequency domain predicted block is derived by transforming the predicted block.

12. The image encoding method of claim 11, wherein the image information includes an FDNR enable flag,
the FDNR enable flag is received through a video parameter set (VPS), a sequence parameter set (SPS), a picture parameter set (PPS) or a slice header, and
if a value of the FDNR enable flag is 1, the FDNR flag is included in the image information.

13. The image decoding method of claim 3, the method further comprising determining whether to perform frequency domain noise removal for a current block,
wherein whether to perform the frequency domain noise removal is determined based on at least one of an FDNR flag and whether a condition predefined based on characteristics of a current block is satisfied or not.

14. An image decoding apparatus, comprising:
an entropy decoder which receives image information including residual information and prediction information;
a predictor which derives a prediction mode for a current block based on the prediction information, and which derives a predicted block for the current block based on the prediction mode;
a frequency domain noise remover which derives a frequency domain predicted block by transforming the predicted block, which derives a frequency domain modified predicted block based on the frequency domain predicted block and frequency correlation coefficients, and which generates a modified predicted block by inverse-transforming the frequency domain modified predicted block;
a residual processor which derives a residual block based on the residual information; and
a reconstruction unit which generates a reconstructed block based on the modified predicted block and the residual block.

15. The image decoding apparatus of claim 14, wherein the residual processor derives quantized transform coefficients based on the residual information, derives transform coefficients by dequantizing the quantized transform coefficients, and generates the residual block including residual samples derived by transforming the transform coefficients, and
the transform applied to the predicted block and the transform applied to the transform coefficients use same transform kernel.
